(19) United States
(12) Patent Application Publication
(10) Pub. No.: US 2010/0286922 A1
(43) Pub. Date: Nov. 11, 2010

(54) METHOD FOR DETECTING AND/OR PROCESSING SEISMIC SIGNALS

(75) Inventor: Flavio Poletto, Gorizia (IT)

Correspondence Address: HAMRE, SCHUMANN, MUELLER & LARSON, P.C., P.O. BOX 2902, MINNEAPOLIS, MN, 55402-0902, US

(73) Assignee: ISTITUTO NAZIONALE DI OCEANOGRAFIA E DI GEOFISICA SPERIMENTALE - OGS, Sgonico (IT)

(21) Appl. No.: 12/812,419

(22) PCT Filed: Jan. 9, 2009
(86) PCT No.: PCT/EP09/50199

§ 371 Date: Jul. 9, 2010

(30) Foreign Application Priority Data
Jan. 11, 2008 (IT) UD2008A000007

(51) Int. Cl. G01V 1/28; G06F 19/00

(52) U.S. Cl. 702/17; 702/14

(57) ABSTRACT

Method for detecting and/or processing seismic signals, for example acoustic and/or elastic waves, generated by a plurality of seismic and/or acoustic sources and acquired by a plurality of seismic and/or acoustic sensors disposed in/on the subsurface, which provides at least a step in which at least a convolution operation is performed, applied to the seismic signals, having an orientation concordant with the orientation of the time axis, to obtain a signal assimilable to a seismic signal reflected by a reflector element disposed in correspondence with the seismic and/or acoustic sensors of the seismic and/or acoustic sources.

### FIELD OF THE INVENTION

The present invention concerns a method for detecting and/or processing seismic signals, that is, signals that are propagated in the subsurface in the form of acoustic and/or elastic waves, generated by seismic sources both natural and artificial.

In particular, the method according to the present invention, applied to seismic signals acquired by means of seismic sensors disposed in the subsurface, allows to obtain and simulate new seismic signals used to supply data to be used in the exploration and study of the subsurface.

### BACKGROUND OF THE INVENTION

It is known, in exploration geophysics, to use methods for the detection and/or processing of seismic signals, for example acoustic and/or elastic waves, generated by artificial seismic sources of the impulsive type, such as for example explosive charges or air guns immersed in water, of the non-impulsive type, for example controlled emission vibrators, or generated in passive seismics by environmental noises and by natural seismic sources, and acquired by seismic sensors, otherwise known as receivers, such as geophones, accelerometers or hydrophones.

These known detection and/or processing methods allow to obtain, starting from the signals acquired, which can be analogical or consist of traces formed by series of temporal samples, seismic signals that represent images of the reflecting layers of the subsurface, that is, seismic sections, and which supply information on the properties of the subsurface examined, so as to allow to determine maps of the properties of the subsurface and to construct geological models usable for the purposes of exploration geophysics.

Among those detection and/or processing methods currently used, the one called interferometry is known. This method is essentially based on cross-correlation and summation processes (discrete summation or continuum integration) of signals produced by a group of suitably distributed sources, and acquired by several seismic sensors. Cross-correlation is a mathematical operator which, applied to two signals represented in the frequency domain by means of the respective Fourier transforms, performs the product of the spectra of amplitude of the two signals and performs the difference of their two phases. The summation operation is performed on the cross-correlated receiver signals and is extended over the space of the sources.

Other known methods that realize the interferometry method effect not only the difference of the phases, but also operations to remove/correct the spectrum of amplitude of the signal, in many cases obtaining results similar to those of the interferometry method as described above. These types of results are partly different due to the different wave form of the signal which is obtained, and the events determined by the boundary conditions set for the signal of the interferometry method.

The interferometry method allows to obtain signals assimilable to the signals that would be generated by seismic sources located in correspondence with and to substitute the seismic sensors. On the case of two receivers, for example, this detection and/or processing method allows to obtain a new signal substantially corresponding to the signal which would be generated by a seismic source located in the place of one of the two receivers, otherwise known as “virtual” source.

It has been demonstrated that this method allows to determine, if the proper conditions exist for the distribution of the sources, the filtering effect of the ground, that is, in mathematical terms, to determine the transfer function of the ground, otherwise known as Green's function, for the signals that are propagated between the receivers. The signal obtained with the interferometry method, in the case of two receivers disposed at two points A and B, is

G_{AB}=ΣᵢS_{Ai}S_{Bi}*

where G_{AB} is the Green's function estimated between points A and B, and S_{Ai}; and S_{Bi} are the Fourier transforms of the signals of the i-th source, acquired respectively in correspondence with the two receivers located at A and B, and the asterisk is the symbol of complex conjugate.

From the mathematical point of view, calculating the cross-correlation is equivalent to performing the convolution operation with the signal reversed in time. In fact, as will be shown hereafter, the convolution achieves the product of the amplitudes and the summation of the phases, and calculating the opposite of the phase of the Fourier transform of a signal, that is, its complex conjugate, is equivalent to reversing the signal along the time axis. Therefore, in the state of the art, the correlation is also defined as convolution with the signal reversed in times, which is in any case different from convolution with signal not reversed along the time axis, that is, taken with its natural orientation along said axis.

The interferometry method has the property of automatically removing the parts in common between the phases of the signals of a same source acquired by different receivers, therefore also transforming unknown signals arriving from an incoherent, random source into signals of the impulsive type. It lends itself to be used successfully for seismic and/or acoustic purposes with unknown, passive and incoherent sources too.

The interferometry method supplies the new direct signals, that is, which are propagated from the “virtual” source to the receivers, together with the relevant new reflected signals (desired signal that represents the objects studied) and together with unwanted reflections and events. The study of such events and the possibility of separating the different fields reflected is an important feature in the analysis and treatment of the new signals thus obtained.

One disadvantage of the interferometry method is that it allows to determine, for the signals that are propagated between two listening points, new direct signals together with reflected signals, but does not allow to treat and construct separately new signals as if instead of the receivers there were reflector elements.

Among the methods used to determine an event or signal, in correspondence with the position of the receivers, the focusing method is also known, which uses and/or combines the signals of a plurality of receivers and sources to obtain a focused signal after having suitably corrected the propagation delays of said signals from the source to the receiver. One disadvantage of the focusing method is that it needs to know these delays and/or to determine a priori the complex properties of the subsurface in order to calculate and compensate, with various techniques, said delays in propagation of the signals to be focused.

Purpose of the present invention is to achieve a method for the detection and/or processing of seismic signals, acquired by means of seismic sensors, which allows to obtain new seismic signals assimilable to those that would be generated by reflector elements disposed in correspondence with and to substitute the seismic sensors/sources, which does not entail a substantially greater calculation complexity than that of the interferometry method, and which does not need to know a priori the properties of the subsurface model and/or to correct the delays in propagation of the signals from source to receiver.

The Applicant has devised, tested and embodied the present invention to overcome the shortcomings of the state of the art and to obtain these and other purposes and advantages.

### SUMMARY OF THE INVENTION

The present invention is set forth and characterized in the independent claim, while the dependent claims describe other characteristics of the invention or variants to the main inventive idea.

In accordance with the above purpose, a detection and/or processing method according to the present invention is able to detect and to process seismic signals, for example acoustic and/or elastic waves, generated by a plurality of seismic sources and acquired by a plurality of seismic and/or acoustic sensors disposed in/on the subsurface.

According to a characteristic feature of the present invention, the processing method comprises at least a convolution operation applied to said signals, having an orientation concordant with the increasing orientation of the time axis, in order to obtain seismic signals assimilable with seismic signals reflected by reflector elements disposed in correspondence with the sensors/sources.

Advantageously the seismic signals comprise traces formed by series of temporal samples.

According to a variant of the present invention, the at least one convolution operation is performed either between signals emitted by at least two seismic sources and acquired by at least one of the seismic sensors, or between signals acquired by at least two seismic sensors and emitted by at least one of the seismic sources.

According to another variant, the present invention provides to perform the summation of the convolution operations for each of the seismic sensors/for each of the seismic sources.

Advantageously, in a perfected form, the processing method according to the present invention provides to analyze the condition of stationarity of the phase of the seismic signals. This analysis is made before said summation of the results of the convolution operations.

The method according to the present invention adds the phases of the different signals and to be used correctly and effectively in order to obtain seismic signals the sources must have known delays.

Advantageously, to apply the method according to the present invention to delayed sources, the delays of the signals of said sources must be determined and corrected.

To apply the method according to the present invention with non-impulsive and/or inconsistent sources, for example vibrators or passive incoherent, random sources, it is necessary to render the signals of said sources impulsive, to correct their delays, if any, after having determined their wave form separately, for example by means of measurements of reference or pilot signals. The correction is applied to the signal of each source to be used with the method according to the present invention and is typically based on correlation or deconvolution methods.

According to an advantageous feature of the present invention, the seismic signals are subjected to filtering operations in order to improve their wave form, thus reducing the level of noise present, and to improve the signal/noise ratio.

The filtering operations can be performed before and/or after the convolution operation.

The operations to improve the signal can be mono-channel or multi-channel, they can include the balancing of the amplitudes with suitable weights and/or the selection of the signal within suitable time windows, for example by detecting the time of the event with a picking operation and by windowing the signal by zeroing the samples that do not belong to the selected window.

The use of the convolution operator allows to obtain a method for processing seismic signals, acquired by means of seismic sensors, which allows to obtain, as new seismic signals, only those that are assimilable to those that would be generated by reflector elements disposed in correspondence with the seismic sensors/seismic sources. The method according to the present invention also allows to identify, confirm, estimate and separate signal and noise, different wave fields and components in original and/or processed seismic traces containing signals due to the actual presence of real reflectors. In particular, according to an improved use of the present invention, the convolutive method can be used in combination with the interferometry method in order to process the corresponding signals obtained with said two processing methods, to estimate and correct their phases, to compose and subtract the delays of the events, to filter inversely the signals with operators determined conjointly, to estimate and separate the wave fields in the zones of interference. Furthermore, the method according to the present invention can be applied to signals produced by virtual sources.

### BRIEF DESCRIPTION OF THE DRAWINGS

These and other characteristics of the present invention will become apparent from the following description of a preferential form of embodiment, given as a non-restrictive example with reference to the attached drawings wherein:

FIG. 1 is a schematic representation of a discrete mathematical model to which the processing method according to the present invention is applied;

FIG. 2 is a modified form of the representation in FIG. 1;

FIG. 3 is another mathematical model to which the processing method according to the present invention is applied;

FIG. 4 is a representation of a first image obtained by juxtaposing a plurality of seismic signals;

FIG. 5 is a representation of a second image obtained by juxtaposing a plurality of seismic signals;

FIG. 6 is a representation of a third image obtained by juxtaposing a plurality of seismic signals;

FIG. 7 is a representation of a fourth image obtained by juxtaposing a plurality of seismic signals;

FIG. 8 is a representation of a first seismic signal;

FIG. 9 is a representation of a second seismic signal;

FIG. 10 is a representation of a third seismic signal;

FIG. 11 is a representation of a fourth seismic signal;

FIG. 12 is a representation of a fifth seismic signal;

FIG. 13 is a representation of a sixth seismic signal.

### DETAILED DESCRIPTION OF A PREFERENTIAL FORM OF EMBODIMENT

The method according to the present invention is able to detect and/or process seismic signals, that is, signals that are propagated in the subsurface in the form of acoustic and/or elastic waves, generated by a plurality of seismic sources and acquired by a plurality of seismic sensors disposed in/on the subsurface in order to obtain seismic signals assimilable to seismic signals reflected by reflector elements disposed in correspondence with said seismic sensors/sources.

In order to achieve this, the method according to the present invention uses the convolution operation.

The convolution between two signals xₖ and yₖ represented as a series of temporal samples with a discrete index k can be expressed as:

$${c}_{j} = {\sum }_{k} {x}_{j - k} {y}_{k}$$

In the frequency domain the convolution operation corresponds to the product of the amplitude spectra and to the summation of the phase spectra of the signals. The convolution of two signals, in the frequency domain, is therefore expressed as the product of the corresponding Fourier transforms of the signals:

C=XY

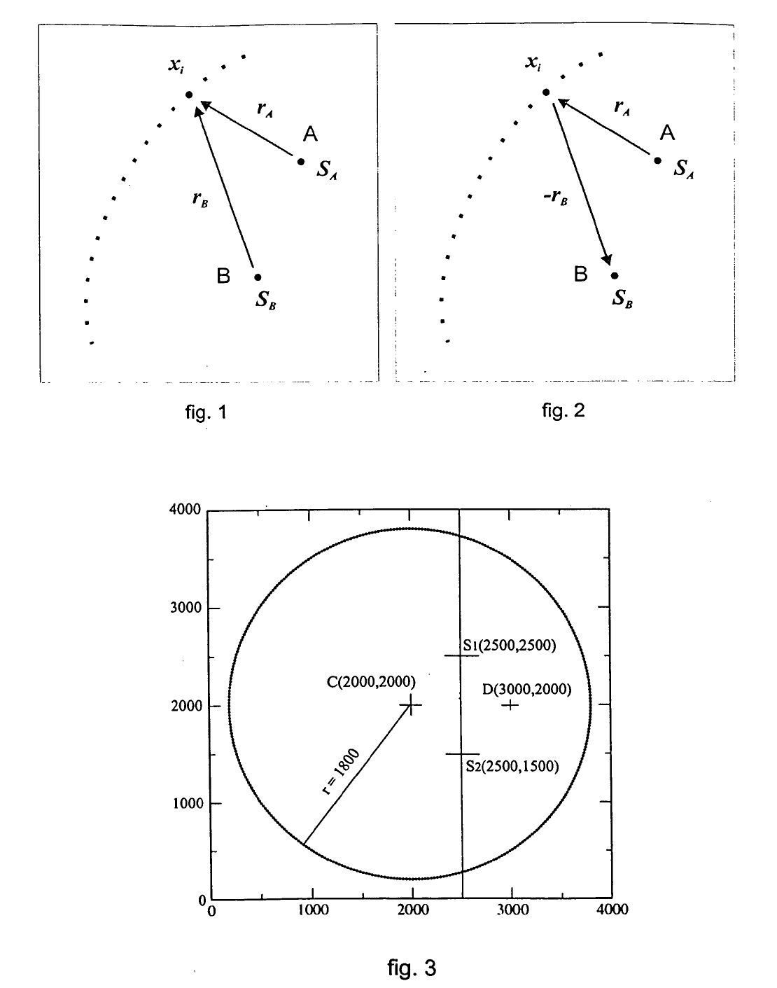

For example, we shall consider two sources S_{A} and S_{B} applied at two points A and B, and xᵢ are the receivers disposed in the proximity of said sources, for example along a recording line as shown in FIG. 1. Each receiver xᵢ measures the signals S_{Ai}; and S_{Bi} produced by the two different sources S_{A} and S_{B}, typically at different moments in time. These signals travel the paths schematically shown by the radii r_{Ai} and r_{Bi}. For each receiver xᵢ point the signals received from the source at A and from the source at B are convolved so as to obtain the following formula:

Cᵢ=S_{Ai}S_{Bi}.

By means of said formula we achieve the composition of the propagation effects shown schematically by the travel radii r_{Ai} and r_{Bi}.

Due to the principle of reciprocity, the signal that is propagated from the source at B to the receiver at x is, under the proper conditions, equivalent to the signal that would be propagated from a source at x to a receiver at B (the same reasoning applies for point A). It is therefore possible to exchange ideally source and receiver of this radius and replace the radius r_{B} with its opposite in direction (FIG. 2). In this way the composition of the radii represents the propagation of the signal emitted by the source at A to the receiver at x and then from x to point B. This signal does not necessarily correspond to a real signal that is generated when a source is used at A and a receiver at B.

Subsequently the convolution method of the signals acquired with the two sources is extended to all the points of the line of receivers x; and the summation of the convolved signals is calculated. The following equation is obtained:

C_{AB}=ΣᵢS_{Ai}S_{Bi}=ΣᵢCᵢ.

This equation represents a new signal, corresponding to the signal between the source point A and the recording point B, as if there were a reflector in the position x of the recording line where the receivers are located, even if such a reflector is not actually present. As a result, we obtain the synthesis of signals produced by the presence of a “virtual” reflector, extending along the recording line.

In the summation operation that is performed after the convolution operation, there are both signals that are added in phase and also signals that are attenuated or cancelled due to interference. In a stationary condition, the signal obtained is therefore a reinforced signal. The condition of phase invariance of the convolved signal as the receiver point varies is analyzed by observing the convolved signals before effecting the summation, so as to determine the stationary points. The distribution of the stationary points or zones of the method according to the present invention is different from the distribution of stationary points or zones of the correlated signals of the interferometry method known in the state of the art.

By referring, for the sake of simplicity, to a model with a constant speed of propagation, for the signals processed by means of the interferometry method we have a stationary condition of the type

r_{A}−r_{B}=constant

whereas for convolved signals calculated by the method according to the present invention we obtain a condition of the type

r_{A}+r_{B}=constant

where the symbol r is used to represent the modulus of the radius.

In this latter case we obtain a stationary condition of an elliptic type, whereas in the case of the interferometry method we have a condition of a hyperbolic type.

The method according to the present invention is applied not only if signals arriving from a plurality of sources are recorded by a single receiver, but, due to the principle of reciprocity, also if signals arriving from a single source are recorded by several receivers.

The method according to the present invention also allows to determine, in association with the known interferometry method, information on the phase of each source signal. In fact, with the phases of the wave forms of the signals at the source at A and at B indicated by φ_{A} and φ₁₃, the interferometry method obtains a signal that contains the phase

φ₁=φ_{A}−φ_{B}

or opposite, whereas with the method according to the present invention we obtain a signal that contains the phase

φ_{R}=φ_{A}+φ_{B}.

Combining the two previous equations we obtain the following equations

$${φ}_{A} = \frac{{φ}_{R} + {φ}_{I}}{2} , \\ {φ}_{B} = \frac{{φ}_{R} - {φ}_{I}}{2} ,$$

which supply information on the phase of the source signals. The phases can be analyzed using corresponding events obtained with the two methods, the method according to the present invention and the interferometry method, and the combinations of the phases can be calculated with phase performance methods.

The phases of the signals obtained with the two methods can generally be added, obtaining the composition of the delays, so as for example to correct in simple times or convert to double times the signals of seismic profiles from a borehole or subtracted in the subsequent processing of the signals, applying inverse filtering operators and/or temporal translation operators.

Furthermore, given that due to their construction the signals obtained with the two methods contain, as factors of their amplitude spectra, the same amplitude spectra, obtained from the product of the amplitude spectra of the signals at the source/receivers, the combination of the method according to the present invention with the known interferometry method allows to process not only the phases but also the amplitudes of the signals transformed in the Fourier domain, and/or allows to filter inversely the signals obtained with the two methods by means of common deconvolution operators, that is, operators calculated using the signals of one or both methods.

The method according to the present invention and the interferometry method can also be combined so as to obtain, when using the same types of data and sources/receivers configurations, the signal in the frequencies

aΣᵢS_{Ai}S_{Bi}+bΣS_{Ai}S_{Bi}*=ΣᵢS_{Ai}(aS_{Bi}+bS_{Bi}*)

where a and b are suitable multiplier constants or variable coefficients of filters in the domain of the Fourier transform. For example it is possible to calculate the combinations

ΣᵢS_{Ai}(S_{Bi}±S_{Bi}*).

In the two previous formulas the contribution of both methods, the convolution method according to the present invention and the correlation method, is obtained by extending the summation, case by case according to the cases treated, to the domain of the receivers or to the domain of the sources.

FIG. 3 shows as a non-restrictive example a mathematical model to which the processing method according to the present invention is applied. In particular, the model is calculated by means of a numerical simulation of acoustic signals by a finite differences code.

The model is a square model with sizes, horizontal X and vertical Z, of 4 km×4 km, propagation speed of the acoustic medium 2000 m/s, speed of the contrasting medium 20000 m/s. A regular grid is used, with intervals Dx=Dz=5 m. A substantially punctual diffractor D, of a substantially circular shape and with a radius of 30 m is positioned at point (3000,2000). A circle of 360 receivers spaced at regular intervals is positioned on a circle with a radius r equal to 1800 m centered at C (2000,2000). Two sources are used, with coordinates S₁ (2500,2500) and S₂ (2500,1500). The wave form of the source signal is a Ricker wavelet with a peak frequency of 30 Hz. The signal produced by the source at S₁ is recorded by the receivers disposed along the circle and by a receiver at point S₂. The seismograms are calculated with a temporal sampling rate of 1 ms, up to a maximum time of 3 s. These data are used to calculate and simulate the signal reflected by the “virtual” reflector consisting of the circle of receivers in the acoustic uniform medium with the diffraction point. A second model has also been calculated, for comparison, in which there is the medium with the strong acoustic contrast in the position of the circle, also called hereafter a “reflector element”.

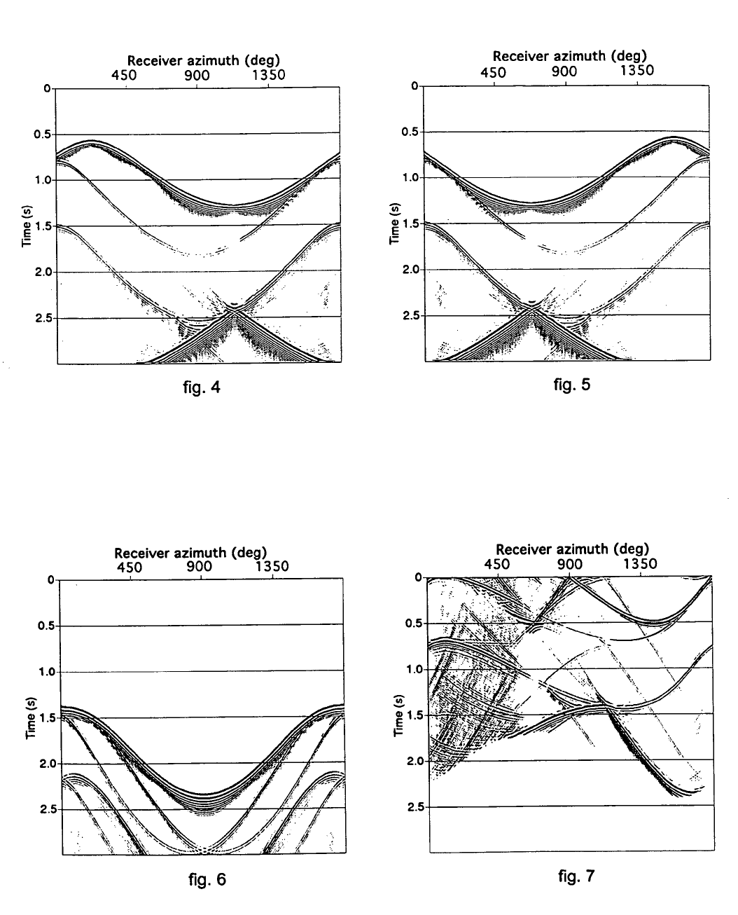

FIG. 4 shows the numerically simulated seismic signal produced by the source at S₁ and recorded by the receivers disposed along the circle in the model with the acoustic contrast in the position of the circle. The image is obtained by juxtaposing the traces of the seismic signals with normalized amplitudes trace by trace.

FIG. 5 shows the numerically simulated seismic signal produced by the source at S₂ and recorded by the receivers disposed along the circle in the model with the acoustic contrast in the position of the circle. The image is obtained by juxtaposing the traces of the seismic signals with normalized amplitudes trace by trace.

FIG. 6 shows the signal produced by the convolution operation and used to analyze the stationary phase conditions before the summation of the convolved signals of the receivers disposed along the circle in the model with the acoustic contrast in the position of the circle. The image is obtained by juxtaposing the traces of the convolved signals with normalized amplitudes trace by trace. A stationary signal is observed at 1.4 s.

FIG. 7 shows the signal produced by the correlation of the reciprocal application of the interferometry method and used to analyze the stationary phase conditions before the summation of the correlated signals of the receivers disposed along the circle in the model with the acoustic contrast in the position of the circle. The image is obtained by juxtaposing the traces of the correlated signals with normalized amplitudes trace by trace. A stationary signal is observed at 1.4 s.

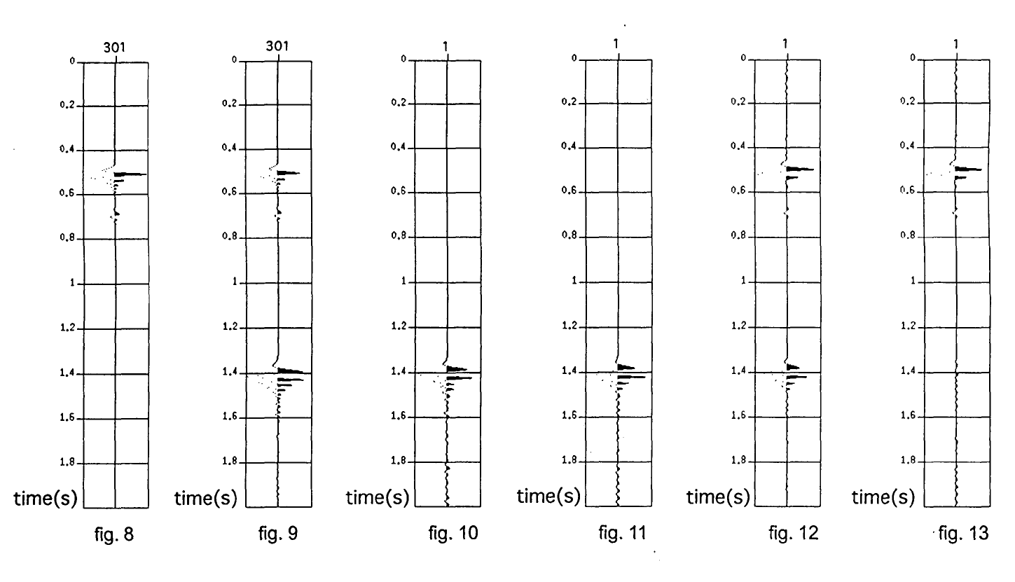

FIG. 8 shows the numerically simulated seismic signal that is propagated from the source S₁ and subsequently recorded by a receiver disposed at S₂, in the absence of the reflector element. The signal in correspondence with 0.5 is the direct signal, the signal in correspondence with 0.7 s is the diffracted signal.

FIG. 9 shows the numerically simulated seismic signal that is propagated from the source S₁ and subsequently recorded by a receiver disposed at S₂, in the presence of the reflector element. The signal in correspondence with 1.4 s is the reflected signal.

FIG. 10 shows the seismic signal that is obtained by applying the method according to the present invention, in the absence of the reflector element. The similarity of the signal obtained with the reflected signal obtained at 1.4 s in FIG. 9 is emphasized.

FIG. 11 shows the seismic signal that is obtained by applying the method according to the present invention, in the presence of the reflector element. The similarity of the signal obtained with the reflected signal obtained at 1.4 s in FIG. 9 and in FIG. 10 is emphasized.

FIG. 12 shows the seismic signal that is obtained by applying the interferometry method, in the presence of the reflector element. The similarity of the signal obtained with the signal shown in FIG. 9 is emphasized.

FIG. 13 shows the seismic signal that is obtained by applying the method according to the present invention which combines the signal of the convolutive method (FIG. 11) and the signal of the interferometry method (FIG. 12), in the presence of the reflector element. It should be observed that from this combination we obtain the result of isolating and subtracting the event reflected at 1.4 s, keeping the direct and diffracted signals unchanged, which can represent an object of interest. The excellent similarity of the signal thus obtained with the seismic signal, calculated between S₁ and S₂ in the absence of the reflector, shown in FIG. 8, is emphasized.

It is clear that modifications and/or additions of parts may be made to the method for processing seismic signals as described heretofore, without departing from the field and scope of the present invention.

For example, it comes within the field of the present invention to provide that the signals acquired by means of the receivers are filtered and/or inversely filtered with deconvolution operators calculated according to the seismic data acquired, in order to improve the wave form of the signals recorded, thus reducing the noise level, and to improve the signal/noise ratio. The operators and/or filters can be applied before and/or after the application of the convolutive calculation procedure provided by the method according to the present invention. Furthermore, suitable temporal windows may be used in order to select the datum to be used in the subsequent step of convolutive processing.

It is also clear that, although the present invention has been described with reference to some specific examples, a person of skill in the art shall certainly be able to achieve many other equivalent forms of method for processing seismic signals, having the characteristics as set forth in the claims and hence all coming within the field of protection defined thereby.

1. A method for detecting and/or processing seismic signals, for example acoustic and/or elastic waves, generated by a plurality of seismic and/or acoustic sources and acquired by a plurality of seismic and/or acoustic sensors disposed in/on the subsurface, wherein it provides at least a step in which at least a convolution operation is performed, applied to said seismic signals, having an orientation concordant with the orientation of the time axis, in order to obtain a signal assimilable to a seismic signal reflected by a reflector element disposed in correspondence with said seismic and/or acoustic sensors/said seismic and/or acoustic sources.

2. The detection and/or processing method as in claim 1, wherein said seismic signals comprise traces formed by series of temporal samples.

3. The detection and/or processing method as in claim 2, wherein said at least one convolution operation is performed between signals emitted by at least two of said seismic and/or acoustic sources and acquired by at least one of said seismic and/or acoustic sensors.

4. The detection and/or processing method as in claim 2, wherein said at least one convolution operation is performed between signals acquired by at least two of said seismic and/or acoustic sensors and emitted by at least one of said seismic and/or acoustic sources.

5. The detection and/or processing method as in claim 3, wherein it performs the summation of said convolution operations for each of said seismic and/or acoustic sensors.

6. The detection and/or processing method as in claim 4, wherein it performs the summation of said convolution operations for each of said seismic and/or acoustic sources.

7. The detection and/or processing method as in claim 1, wherein said seismic and/or acoustic sources are “virtual” sources.

8. The detection and/or processing method as in any claim 1, wherein it provides at least a step in which the stationary condition of said seismic signals is analyzed.

9. The detection and/or processing method as in claim 8, wherein said analysis of the stationary condition of said seismic signals is carried out before said summation of said convolution operations.

10. The detection and/or processing method as in claim 8, wherein said stationary condition is of the elliptic type.

11. The detection and/or processing method as in any claim 1, wherein it provides at least a step in which said seismic signals are processed to correct their delays.

12. The detection and/or processing method as in any claim 1, wherein it provides at least a step in which the wave form of the source is corrected/modified so as to obtain wave forms with desired characteristics.

13. The detection and/or processing method as in claim 1, wherein it provides at least a step in which non-impulsive and/or incoherent, random seismic signals are made impulsive after having determined the wave form of said non-impulsive and/or incoherent seismic signals by means of reference signals.

14. The detection and/or processing method as in claim 13, wherein said reference signals are used to correct the wave form and/or phase of said non-impulsive and/or incoherent seismic signals.

15. The detection and/or processing method as in claim 14, wherein said correction comprises correlation and/or deconvolution operations.

16. The detection and/or processing method as in claim 1, wherein it provides at least a step in which, in association with interferometry methods, information is obtained on the phase and/or on the delay of said seismic signals and in which said seismic signals are processed by means of said information.

17. The detection and/or processing method as in claim 16, wherein a seismic signal containing a phase φ_{R} is obtained, wherein said information on the phase of said seismic signals is obtained by means of the formulas
$${φ}_{A} = \frac{{φ}_{R} + {φ}_{I}}{2} and \text{/} or {φ}_{B} = \frac{{φ}_{R} - {φ}_{I}}{2} ,$$
where φ_{A} and φ_{B} correspond to the phases of said seismic signals generated/detected by sources/receivers located respectively at points A and B, and φ₁ corresponds to the phase of the signal obtained with interferometry methods.

18. The detection and/or processing method as in claim 1, wherein it provides at least a step in which, in association with interferometry methods, information is obtained on the spectrum of amplitude of said seismic signals.

19. The detection and/or processing method as in claim 1, wherein it provides at least a step in which, in association with interferometry methods, it allows to process and/or filter inversely by means of common deconvolution operators, the signals assimilable to reflected signals and the signals obtained by means of said interferometry methods.

20. The detection and/or processing method as in claim 1, wherein, combined with the known interferometry method, it allows to insulate and/or separate the reflected seismic signal and/or seismic wave fields.

21. The detection and/or processing method as in claim 20, wherein it is combined with interferometry methods according to the formula aΣᵢS_{Ai}S_{Bi}+bΣᵢS_{Ai}S_{Bi}*=ΣᵢS_{Ai}(aS_{Bi}+bS_{Bi}*) where a and b are multiplication constants and/or variable coefficients of filters in the domain of the Fourier transform, and S_{Ai}; and S_{Bi} are signals produced/measured respectively by two sources/two receivers at two points A and B.

22. The detection and/or processing method as in claim 21, wherein the summation in said formula is extended to the domain of the receivers.

23. The detection and/or processing method as in claim 21, wherein the summation in said formula is extended to the domain of the sources.

24. The detection and/or processing method as in claim 1, wherein it provides at least a step in which said seismic signals are processed in order to reduce the noise level of said seismic signals and to improve the signal-to-noise ratio.

25. The detection and/or processing method as in claim 24, wherein said processing is performed before said at least one convolution operation.

26. The detection and/or processing method as in claim 24, wherein said processing is mono-channel.

27. The detection and/or processing method as in claim 24, wherein said processing is multi-channel.

28. The detection and/or processing method as in claim 24, wherein said processing comprises the balancing of the amplitudes of said seismic signals by using weights.

29. The detection and/or processing method as in claim 24, wherein said processing comprises filtering and/or inverse filtering operations.

30. The detection and/or processing method as in claim 24, wherein said processing comprises the selection of said seismic signals in suitable temporal windows.

31. The detection and/or processing method as in claim 24, wherein said processing is performed after said at least one convolution operation.
